(19) United States
(12) Patent Application Publication
(10) Pub. No.: US 2004/0065830 A1
(43) Pub. Date: Apr. 8, 2004

(54) Apparatus and process for measuring flowing bulk material by light-reflection

(76) Inventors: Paul Boon, Nieuwrode (BE); Luc Van Steerteghem, Nieuwerken-Waas (BE); Jos Croonenborghs, Meehour (BE)

Correspondence Address: Richard J Minnich, Fay Sharpe Fagan Minnich & McKee, 7th Floor, 1100 Superior Avenue, Cleveland, OH, 44114-2518, US

(21) Appl. No.: 10/250,450

(22) PCT Filed: Dec. 28, 2000
(86) PCT No.: PCT/EP00/13312

(51) Int. Cl. G01N 21/35; G01N 21/31

(52) U.S. Cl. 250/339.11; 356/945; 356/300

(57) ABSTRACT

An apparatus and process for measuring bulk material flowing in a pipe by light reflection, the pipe having at least one window (24a,24b,24c) consisting of a light-transmissible material, an analyser (19) being arranged outside the at least one window for emitting light and measuring the light reflected by the bulk material in the pipe, characterised in that the pipe has an elbow having a first pipe section (14) at its entrance side and a second pipe section at its exit side, at least one window being provided in a plate (9) at the outside of the elbow, which plate is arranged at an angle to the axis of the first pipe section.

The present invention relates to an apparatus and a process for measuring bulk material properties flowing in a pipe by light reflection and to the use of this apparatus.

When a pipe is provided with a light transmissible window it is possible to perform measurements of the bulk material flowing in the pipe, such as powder size, colours, chemical compositions, chemical and physical properties etc. by using light, such as UV, visible or IR-light.

For instance, NIR is a subregion of IR light and to measure the near infrared (NIR) spectrum of a polyolefin powder in a pneumatic or gravity transport pipe a sapphire window was inserted in the pipe wall and an analyser was provided outside the window which emits and measures the IR-radiation reflected by the bulk material inside the pipe. However, the quality of the NIR spectra were poor both for qualitative and quantitative analysis.

DE4014739C2 discloses an apparatus for measuring the light absorption of solid particles in a liquid flowing in a pipe by light transmission. The apparatus has a curved pipe section. The measurement element is mounted in a region of the curved section in which higher flow speeds occur than in other regions to prevent solid deposits between the emitter which transmits the light through the liquid to the opposite detector of the measurement element.

U.S. Pat. No. 5,459,318 discloses a flui bed 16 in a bowl. To monitor the moisture of the particulate material of the fluid bed an NIR probe is attached to the bowl wall. The probe consists of a conduit having a perpendicular window spaced away from the bowl wall.

It is the object of the present invention to provide good quality of reflected light spectra of bulk materials flowing in a pipe.

This object is attained by using a pipe with an elbow, at least one window in a plate or a flat surface at the outside of the elbow and a light reflection analyser outside the window, so that light sent through the window is reflected by the bulk material and measured by the analyser detector, the plate being arranged in such a way between the entrance side and the exit side of the elbow that the bulk material incoming from the entrance side is deflected by the plate to the exit side of the elbow.

The elbow is preferably an elbow for connecting two pipes at an angle of 90°, particularly an elbow according to U.S. Pat. No. 5288111, that is a 90° elbow adapted for use in a transport pipe and defining an inner elbow side and an outer elbow side, comprising: a first pipe section or socket for attachment of a pipe; a first pipe portion defining an axis and being connected to said pipe section, said first pipe section including a flared pipe shell extending at the inner elbow side to provide said first pipe section with a cross-sectional expansion expanding in a direction away from said first pipe section; a pipe bend including a quadrantal pipe shell connected to said flared pipe shell at the inner elbow side; a second pipe section including a cylindrical shell which is connected to said quadrantal pipe shell at said inner elbow side, and a tapered pipe shell connected to said cylindrical shell at the outer elbow side to provide said second pipe section with a cross-sectional contraction contracting in a direction away from said quadrantal pipe shell; said pipe bend further including a baffle plate arranged between said first pipe section and said second pipe section and connected thereto at the outer elbow side and being oriented relative to said axis of said first pipe section at an angle between 55° and 65°; and a second pipe section connected to said second pipe section for attachment of another pipe.

Of course, also other elbow forms are possible.

The elbow according to U.S. Pat. No. 5,288,111 is particularly preferred, because the light transmissible window can easily be inserted in the baffle plate to form a window for light reflection measurement, and because the impact of the product on the baffle plate guarantees firstly a measurement made on full representative product sample as a moving product layer is built up which is presented for light reflection and secondly a self cleaning effect of the window.

Although a 90° elbow is preferred, the elbow may have another angle. Generally, according to the invention the light-transmissible window at the outside of the elbow at which the reflection analyser is mounted is arranged at an angle between more than 30° and less than 80° to the axis of the first pipe section.

In addition, to deflect the incoming bulk material at the plate to the exit side of the elbow, the plate has to be inclined to the axis of the pipe section at the entrance side, preferably at an angle of at least 200 smaller than the angle between the axes of the first and the second pipe sections.

However, when a 90° elbow is used, the window plate is preferably arranged at an angle between 55° and 65° to the axis of the first pipe section.

Preferably, the cross-section of the elbow increases from the first pipe section to the plate in the 90° elbow. For cross-sectional expansion in particular in the 90° elbow the first pipe portion between the first pipe section and the window plate includes a flared pipe shell extending at the inner elbow side expanding in a directional way from the first pipe section.

The first and the second pipe section of the elbow may be arranged at the same height or at a different height. For instance, the pipe axis of the first section at the entrance side of the elbow as well as the pipe axis of the second section and the axis side may lie in the same horizontal plane or in case of a 90° elbow the axis of the first pipe section may be arranged horizontally and the pipe axis of the second section vertically.

According to the present invention, the bulk material incoming from the entrance side of the elbow is deflected by the window plate to the exit side of the elbow to build a continuous moving layer in front of the window, so flat that an effective reflective light-spectrum can be obtained. In addition, the impact of the bulk material on the window plate has a self-cleaning effect.

The light used for measurement according to the invention can be any light or radiation reflected by the bulk material which passes the window. That is UV, visible light, or IR-light can be used to perform all kinds of measurements which are possible through a window in the baffle plate of the elbow, such as particle size, colours, chemical compositions, chemical and physical properties etc.

The invention is particularly suitable for measuring bulk material flowing in a pipe by IR-spectroscopy that is, in particular, for granulate, powder or pellet material. In this case, the at least one window consists of IR-transmissible material and the analyser emits IR-radiation and measures the IR-radiation reflected by the bulk material in the pipe.

The IR-analyser arranged outside the window or baffle plate can be any analyser used for reflection IR-spectroscopy of solids, in particular a commercial NIR reflection IR-analyser. As a reflection IR-analyser one can use an AOTF (acousto-optical tunable filter) spectrometer for instance.

The bulk material to be measured with the apparatus according to the present invention can be any bulk material, in particular bulk material in form of powder, granules, or pellets. The bulk material may have any particle size being used in pneumatic transport systems. As conveying gas for the pneumatic transport system for instance air, nitrogen, oxygen, propane, propylene and mixtures of these gases can be used.

The NIR-spectra of powders and granules show a particular high improvement.

The volume ratio of the solids of the bulk material to the gas in the pipe is preferably 1:10 to 50:1, in particular 1:1 to 8:1.

The apparatus of the present invention can be used to measure physical or chemical properties of inorganic or organic bulk materials flowing in a pipe by light reflection using UV, visible or IR light, that is in particular from 10⁻⁸ to 10⁻¹ cm, preferably from 10⁻⁵ to 10⁻² cm. All kinds of light reflection can be used, including fluorescence and Raman spectroscopy. It is particularly usable for IR-analysis, in particular NIR subregion of the IR region. For instance, the quality of bulk material may be controlled. In particular in a process in which bulk material is produced the bulk material may be analyzed in accordance with the present invention. Such a process is, for instance, a polymerization process in which the polymer is obtained in form of bulk material. A particularly preferred use of the present invention is the analysis of polyolefins, auch as polymers or copolymers of ethylene or propylene.

The pipe in which the elbow is inserted may have any inner diameter suitable for pneumatic transport application.

When the transport of the bulk material in the pipe has been stopped and is started again the bulk material may be blocked in front of the window or windows, respectively. Thus, flushing with a gas stream, as nitrogen gas with a high pressure of for instance 5 to 30 barg can be applied to bring the bulk material in front of the windows in motion. Once flushed a couple of times, the bulk material starts flowing and stays flowing without further flushing.

However, flushing can be omitted when the inner diameter of the first section at the inlet of the elbow is restricted by a conical reducing baffle which speeds up the stream of bulk material so that the material is brought in motion in front of the windows. That means, by reducing the inner diameter of at least the first pipe section the problem of blocking the window at the start can be overcome.

That is, the flow of materials depends on the right flow pattern, mass flow and speeds. One can use flushing with a gas stream to solve problems of not having enough material presence on the window, or to change the flow pattern or speed with extra restrictions.

However, proper flowing and formation of the moving product layer in front of the window can be modified by changing the diameter of the entrance pipe to the gamma bend and/or by flushing the gamma bend by transport gas.

A preferred embodiment of the apparatus of the present invention will now be described with reference to the drawings in which:

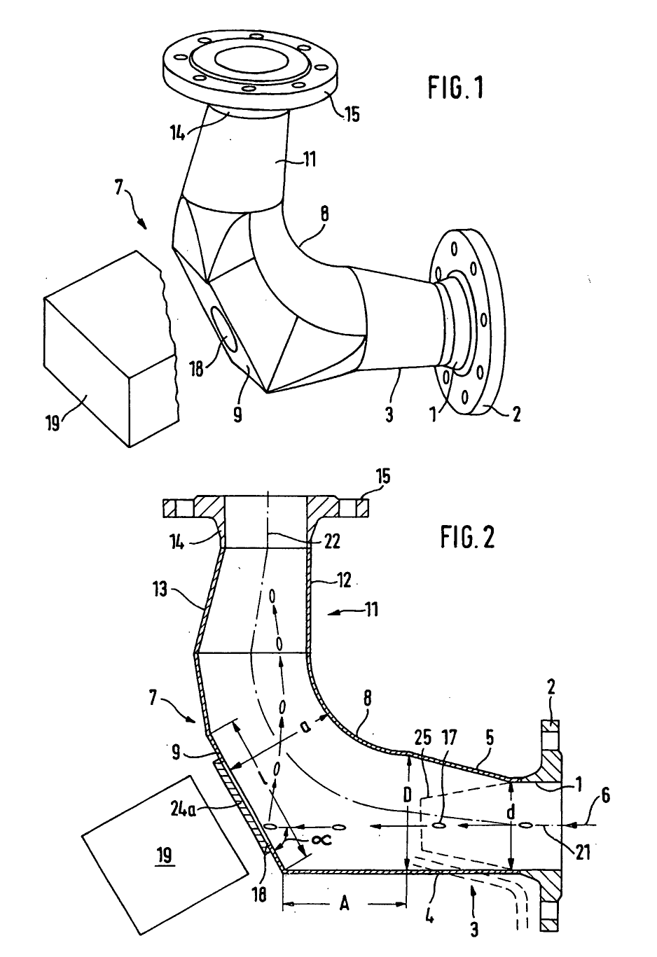

FIG. 1 is a perspective illustration of an apparatus according to the present invention;

FIG. 2 is a schematic longitudinal section of the apparatus of FIG. 1;

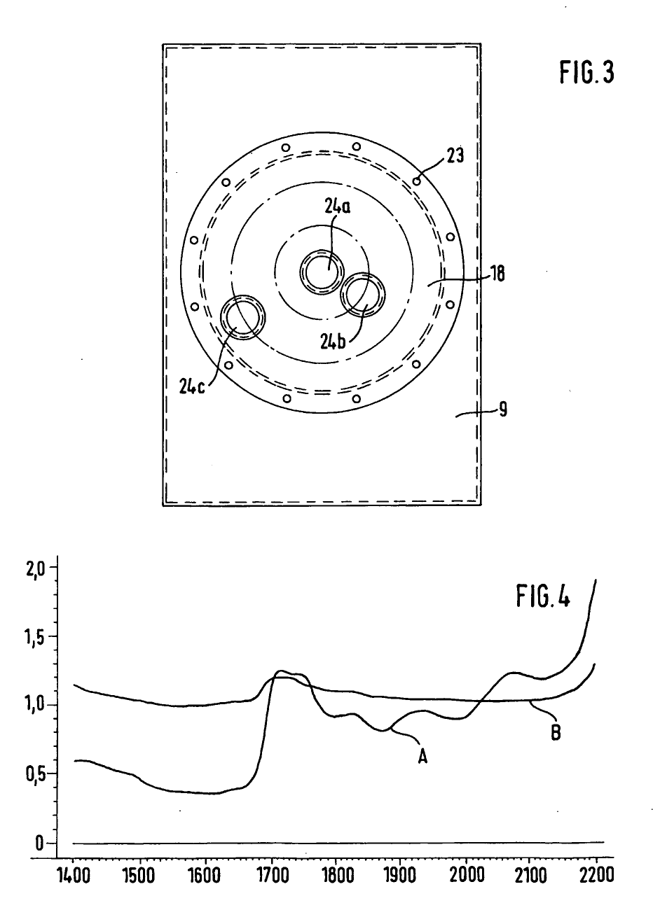

FIG. 3 is a plan view of the window and

FIG. 4 are NIR-spectra.

According to FIGS. 1 and 2, an elbow for connecting pipes (not shown) at an angle of 90° includes a cylindrical pipe socket or section 1 which is provided with a flange 2 for attachment to one pipe. At its flange-distant end, pipe section 1 is connected to a first pipe portion 3. As can be seen from FIG. 2, the first pipe portion 3 has a cylindrical shell 4 extending at the outer elbow side and connected to a flared upper shell 5 at the inner elbow side. Thus, the first pipe portion 3 has a continuously expanding cross-sectional area in flow direction indicated by arrow 6. Following pipe portion 3 is a pipe bend 7 including a quadrantal pipe shell 8 at the inner elbow arch and a baffle plate 9 at the outer elbow arch in opposition to pipe shell 8. Baffle plate 9 is connected with a number of suitable segments to quadrantal pipe shell 8 to form a closed cross-sectional area. The pipe bend 7 is followed by a second pipe portion 11 which includes a cylindrical shell 12 which extends at the inner elbow side that is connected to a tapered shell 13 which extends at the outer elbow side so that the cross-sectional area of pipe section 11 is continuously reduced. Pipe portion 11 ends in a diameter corresponding to the nominal diameter of a following pipe socket or section 14 which is provided with a flange 15 for attachment to the other pipe (not shown).

As shown in FIG. 2 the cone angle of the conical shell 5 and/or the length of the first pipe portion 3 are selected in such a manner that the bulk material particles 17 transported along arrows 6 always detach from the wall surface in the area of the first pipe portion 3. Moreover, the conveying speed is diminished by means of this cross-sectional extension.

Tightly fixed in a cut-out of plate 9 is a disc 18 provided with tightly fixed discs or plates 24a, 24b, and 24c of NIR-transmissible material (FIG. 3) which serve as windows for reflection IR-spectroscopy with an NIR-spectrometer or analyser 19 (from which a part is broken away in FIG. 1).

Plate 9 is arranged at an angle α between 55° and 65° relative to the axis 21 of the first pipe section 1 at the entrance side of the elbow. Because the angle between the axis 21 of the first pipe section and the axis 22 of the second pipe section 14 is 90°, angle α is about 25 to 35 degrees smaller.

As can be seen from FIG. 3, disc 18 is tightly fixed with bolts 23 to plate 9. In addition, window 24a is arranged in the center of disc 18, whereas the other discs 24b and 24c are radially offset in a different direction and at a different distance from the center.

One or more discs 24a, 24b, and 24c are provided because the optimum particle flow is unpredictable. However, it is also possible to provide windows which reach nearly the entire area of the disk or cover 18. A very fair and dense flow of a bulk material is attained with window 24a at a 12 o'clock location.

The diameter D at the outlet side of the first pipe portion 3 is about 1.2 to 1.5 times the diameter d at the entrance side of the first pipe portion 3. The distance a between the leading edge of the entrance side of plate 9 and the exit side of the first pipe portion 3 corresponds at least to diameter D. The plate 9 is spaced from the quadrantal pipe shell by a minimum distance a which does not significantly exceed diameter D. Plate 9 has a length 1 which corresponds to about 1.5 times to 2 times diameter d. The second pipe portion 11 is designed in the same manner as the first pipe portion 3, i.e. with the same configuration and same dimensions.

As indicated in FIG. 2 a diameter reducing funnel 25 can be inserted in the first pipe portion 3 for accelerating the flow speed. In addition, as indicated in FIG. 2 a gas inlet pipe 26 can be provided in the first pipe portion 3 directed to baffle plate 9 to enable long or short term changes of the flow pattern.

In practice, typical operation conditions are for example as follows:

Pick-up conditions: about 50 to about 90° C. against about 0,2 to about 1 barg, in particular about 70° C. against about 0,45 barg.

Product throughput: about 5 to 80 t/h, in particular about 25,5 t/h

Solids to air ratio: about 1.0 to 3.0, in particular about 1.6

Product speed at the elbow inlet: 10 to about 60 m/sec., in particular about 30 m/sec.

Product speed at the reducing baffle outlet: 20 to 60 m/sec., in particular about 40 m/sec.

These conditions apply in particular for an elbow with diameters of the first and the second pipe sections of 254 mm to 356 mm (10 to 12 inches) having a 30% conical reduction baffle:

The following example serves as further illustration of the invention.

### EXAMPLE

With an apparatus as shown in FIGS. 1 to 3 having as analyser 19 an AOTF spectrometer an NIR-spectrum is collected. As windows 24a, 24b, 24c one uses sapphire windows.

The inner diameter of the first and second pipe sections 1 and 14 are 356 mm (12 inches), respectively.

As bulk material flowing through the pipe polypropylene powder was used for the NIR-spectrum A of FIG. 4. The flow speed is 30 m/s. The solids to gas volume ratio is 4.0.

### COMPARISON EXAMPLE

The above example was repeated, however, a different apparatus was used that is, a pipe with a diameter of 356 mm (12 inches) having a circular curved 90 degree bend with a radius of 4.50 m and a window in the middle of the outer periphery of the bend. The obtained NIR spectrum B is shown in FIG. 4.

As can be clearly seen spectrum A shows a significant improvement of the signal to noise ratio compared with spectrum B.

1. An apparatus for measuring bulk material flowing in a pipe from its entrance side to its exit side by light reflection, the pipe having at least one window (24a, 24b, 24c) consisting of a light-transmissible material, an analyser (19) being arranged outside the at least one window for emitting light and measuring the light reflected by the bulk material in the pipe, characterized in that the pipe has an elbow having a first pipe section (1) at its entrance side and a second pipe section (14) at its exit side, at least one window (24a, 24b, 24c) being provided in a plate (9) at the outside of the elbow, which plate (9) is arranged at an angle (α) to the axis (21) of the first pipe section (1).

2. The apparatus according to claim 1, characterized in that the bulk material flowing in the pipe is measured by NIR-spectroscopy, the at least one window consists of an NIR-transmissible material, and the analyser (19) emits NIR-radiation and measures the NIR-radiation reflected by the bulk material in the pipe.

3. The apparatus according to claim 1, characterized in that the bulk material flowing in the pipe is measured by visible light spectroscopy, the at least one window consists of a visible light transmissible material, and the analyser (19) emits visible light and measures the visible light reflected by the bulk material in the pipe.

4. The apparatus according to claim 1 characterized in that the plate (9) is arranged at an angle (α) between 30° and 80° to the axis (21) of the first pipe section (1).

5. The apparatus according to claim 1 or 2, characterized in that the angle (α) of the plate (9) to the axis (21) of the first pipe section (i) is at least 20° smaller than the angle between the axes of the first and the second pipe sections (1, 14).

6. The apparatus according to one of the preceding claims, characterized in that the cross-section (d, D) of the elbow increases from the first pipe section (1) to the plate (9).

7. The apparatus according to one of the preceding claims, characterized in that a diameter reducing funnel (25) is inserted in the first pipe portion (3) for accelerating the flow speed.

8. The apparatus according to one of the preceding claims, characterized in that a gas inlet pipe (26) is provided in the first pipe portion (3) which is directed to the plate (9).

9. The apparatus according to one of the preceding claims, characterized in that the pipe is a pneumatic transport pipe.

10. The apparatus according to one of the preceding claims, characterized in that the first and the second pipe sections (1, 14) of the elbow are arranged at the same or at a different height.

11. A process for measuring bulk material flowing in a pipe by light reflection, the pipe being provided with at least one window (24a, 24b, 24c) consisting of light-transmissible material, an analyser (19) being arranged outside the at least one window (24a, 24b, 24c) which emits light and measures the light reflected inside the pipe by the bulk material, characterized in that the at least one window (24a, 24b, 24c) is formed in a plate (9) at the outside of an elbow in the pipe, which plate (9) deflects the bulk material incoming from the entrance side to the exit side of the elbow.
